(19) United States
(12) Patent Application Publication
(10) Pub. No.: US 2012/0242795 A1
(43) Pub. Date: Sep. 27, 2012

(54) DIGITAL 3D CAMERA USING PERIODIC ILLUMINATION

(76) Inventors: Paul James Kane, Rochester, NY (US); Sen Wang, Rochester, NY (US)

(21) Appl. No.: 13/070,849

(22) Filed: Mar. 24, 2011

(51) Int. Cl. H04N 13/02

(52) U.S. Cl. 348/46; 348/E13.074

(57) ABSTRACT

A method of operating a digital camera, includes providing a digital camera, the digital camera including a capture lens, an image sensor, a projector and a processor; using the projector to illuminate one or more objects with a sequence of patterns; and capturing a first sequence of digital images of the illuminated objects including the reflected patterns that have depth information. The method further includes using the processor to analyze the first sequence of digital images including the depth information to construct a second, 3D digital image of the objects; capturing a second 2D digital image of the objects and the remainder of the scene without the reflected patterns, and using the processor to combine the 2D and 3D digital images to produce a modified digital image of the illuminated objects and the remainder of the scene.

### CROSS-REFERENCE TO RELATED APPLICATIONS

Reference is made to commonly assigned, co-pending U.S. patent application Ser. No. 12/889,818, filed Sep. 24, 2010, entitled “Coded aperture camera with adaptive image processing”, by P. Kane, et al.; commonly assigned, co-pending U.S. patent application Ser. No. 12/612,135, filed Nov. 4, 2009, entitled “Image deblurring using a combined differential image”, by S. Wang, et al.; commonly assigned, co-pending U.S. patent application Ser. No. 13/004,186, filed Jan. 11, 2011, entitled: “Forming 3D models using two range images”, by S. Wang et. al.; to commonly assigned, co-pending U.S. patent application Ser. No. 13/004/196, filed Jan. 11, 2011, entitled: “Forming 3D models using multiple range images”, by S. Wang et. al.; and to commonly assigned, co-pending U.S. patent application Ser. No. 13/004,229, filed Jan. 11, 2011, entitled: “Forming range maps using periodic illumination patterns”, by S. Wang et. al., the disclosures of which are all incorporated herein by reference.

### FIELD OF THE INVENTION

This invention pertains to the field of capturing images using digital cameras, and more particularly to a method for capturing three-dimensional images using projected periodic illumination patterns.

### BACKGROUND OF THE INVENTION

In recent years, applications involving three-dimensional (3D) computer models of objects or scenes are becoming increasingly common. For example, 3D models are commonly used to create computer generated imagery for entertainment applications such as motion pictures, computer games, social-media and Internet applications. The computer generated imagery is viewed in a conventional two-dimensional (2D) format, or alternatively is viewed in 3D using stereographic imaging systems. 3D models are also used in many medical imaging applications. For example, 3D models of a human body are produced from images captured using various types of imaging devices such as CT scanners. The formation of 3D models can also be valuable to provide information useful for image understanding applications. The 3D information is used to aid in operations such as object recognition, object tracking and image segmentation.

With the rapid development of 3D modeling, automatic 3D shape reconstruction for real objects has become an important issue in computer vision. There are a number of different methods that have been developed for building a 3D model of a scene or an object. Some methods for forming 3D models of an object or a scene involve capturing a pair of conventional two-dimensional images from two different viewpoints. Corresponding features in the two captured images are identified and range information (i.e., depth information) is determined from the disparity between the positions of the corresponding features. Range values for the remaining points are estimated by interpolating between the ranges for the determined points. A range map is a form of a 3D model which provides a set of z values for an array of (x,y) positions relative to a particular viewpoint. An algorithm of this type is described in the article “Developing 3D viewing model from 2D stereo pair with its occlusion ratio” by Johari et al. (International Journal of Image Processing, Vol. 4, pp. 251-262, 2010).

Another method for forming 3D models is known as structure from motion. This method involves capturing a video sequence of a scene from a moving viewpoint. For example, see the article “Shape and motion from image streams under orthography: a factorization method” by Tomasi et al. (International Journal of Computer Vision, Vol. 9, pp. 137-154, 1992). With structure from motion methods, the 3D positions of image features are determined by analyzing a set of image feature trajectories which track feature position as a function of time. The article “Structure from Motion without Correspondence” by Dellaert et al. (IEEE Computer Society Conference on Computer Vision and Pattern Recognition, 2000) teaches a method for extending the structure in motion approach so that the 3D positions are determined without the need to identify corresponding features in the sequence of images. Structure from motion methods generally do not provide a high quality 3D model due to the fact that the set of corresponding features that are identified are typically quite sparse.

Another method for forming 3D models of objects involves the use of “time of flight cameras.” Time of flight cameras infer range information based on the time it takes for a beam of reflected light to be returned from an object. One such method is described by Gokturk et al. in the article “A time-of-flight depth sensor-system description, issues, and solutions” (Proc. Computer Vision and Pattern Recognition Workshop, 2004). Range information determined using these methods is generally low in resolution (e.g., 128×128 pixels).

Other methods for building a 3D model of a scene or an object involve projecting one or more structured lighting patterns (e.g., lines, grids or periodic patterns) onto the surface of an object from a first direction, and then capturing images of the object from a different direction. For example, see the articles “Model and algorithms for point cloud construction using digital projection patterns” by Peng et al. (ASME Journal of Computing and Information Science in Engineering, Vol. 7, pp. 372-381, 2007) and “Real-time 3D shape measurement with digital stripe projection by Texas Instruments micromirror devices (DMD)” by Frankowski et al. (Proc. SPIE, Vol. 3958, pp. 90-106, 2000). A range map is determined from the captured images based on triangulation.

The equipment used to capture the images used for 3D modeling of a scene or object is large, complex and difficult to transport. For example, U.S. Pat. No. 6,438,272 to Huang et al describes a method of extracting depth information using a phase-shifted fringe projection system. However, these are large systems designed to scan large objects, and are frequently used inside of a laboratory. As such, these systems do not address the needs of mobile users.

U.S. Pat. No. 6,549,288 to Migdal et al. describes a portable scanning structured light system, in which the processing is based on a technique that does not depend on the fixed direction of the light source relative to the camera. The data acquisition requires that two to four images be acquired.

U.S. Pat. No. 6,377,700 to Mack et al. describes an apparatus having a light source and a diffracting device to project a structured light pattern onto a target object. The apparatus includes multiple imaging devices to capture a monochrome stereoscopic image pair, and a color image which contains texture data for a reconstructed 3D image. The method of reconstruction uses both structured light and stereo pair information.

US20100265316 to Sall et al. describes an imaging apparatus and method for generating a depth map of an object in registration with a color image. The apparatus includes an illumination subassembly that projects a narrowband infrared structured light pattern onto the object, and an imaging subassembly that captures both infrared and color images of the light reflected from the object.

US2010/0299103 to Yoshikawa describes a 3D shape measurement apparatus comprising a pattern projection unit for projecting a periodic pattern onto a measurement area, a capturing unit for capturing an image of the area where the pattern is projected, a first calculation unit for calculating phase information of the pattern of the captured image, a second calculation unit for calculating defocus amounts of the pattern in the captured image, and a third calculation unit for calculating a 3D shape of the object based on the phase information and the defocus amounts.

Although compact digital cameras have been constructed that include projection units, these are for the purpose of displaying traditional 2D images that have been captured and stored in the memory of the camera. U.S. Pat. No. 7,653,304 to Nozaki et al. describes a digital camera with integrated projector, useful for displaying images acquired with the camera. No 3D depth or range map information is acquired or used.

There are also many examples of projection units that project patterned illumination, typically for purposes of setting focus. In one example, U.S. Pat. No. 5,305,047 to Hayakawa et al describes a system for auto-focus detection in which a stripe pattern is projected onto an object in a wide range. The stripe pattern is projected using a compact projection system composed of an illumination source, a chart, and a lens assembly. A camera system incorporating the compact projection system and using it for auto-focus is also described. This is strictly a focusing technique; no 3D data or images are obtained.

There remains a need for a method of capturing 3D digital images, from which 3D computer models are derived, in a portable device that can also conveniently capture 2D digital images.

### SUMMARY OF THE INVENTION

The present invention represents a method for operating a digital camera, comprising:

providing a digital camera, the digital camera including a capture lens, an image sensor, a projector and a processor;

using the projector to illuminate one or more objects with a sequence of patterns;

capturing a first sequence of digital images of the illuminated objects including the reflected patterns that have depth information;

using the processor to analyze the first sequence of digital images including the depth information to construct a 3D digital image of the objects;

capturing a second 2D digital image of the objects and the remainder of the scene without the reflected patterns, and; using the processor to combine the 2D and 3D digital images to produce a modified digital image of the illuminated objects and the remainder of the scene.

This invention has the advantage that a portable digital camera is used to simultaneously acquire 2D and 3D images useful for the creation of 3D models, the viewing of scenes at later times from different perspectives, the enhancement of 2D images using range data, and the storage of 3D image data into and from a database.

### BRIEF DESCRIPTION OF THE DRAWINGS

FIG. 1 is a flow chart of a method of operating a digital camera to produce a modified digital image of a scene using structured illumination;

FIG. 2 is a schematic of a digital camera and digital projection device, in which the digital camera has two lenses and two sensors, one high resolution sensor and one low resolution sensor;

FIG. 3 is a flow chart of operations within the step of combining 2D and 3D images, wherein a scene range map and point spread function are estimated and used to produce modified digital images;

FIG. 4 is a flow chart of operations within the step of combining 2D and 3D images, wherein a scene range map is estimated, the main subject in the scene is detected, and both are used to produce modified digital images;

FIG. 5 is a flow chart of operations within the step of combining 2D and 3D images, wherein a scene range map is estimated, tone scale changing parameters are produced, and both are used to produce modified digital images;

FIG. 6 is a flow chart of operations within the step of combining 2D and 3D images, wherein a scene range map is estimated, new image view points are produced, and both are used to produce stereoscopic image pairs; and

FIG. 7 is a flow chart of operations within the step of combining 2D and 3D images, wherein a scene range map is estimated, and objects are inserted and removed from the images, producing modified digital images.

It is to be understood that the attached drawings are for purposes of illustrating the features of the invention and is not to scale.

### DETAILED DESCRIPTION OF THE INVENTION

In the following description, some embodiments of the present invention will be described in terms that would ordinarily be implemented as software programs. Those skilled in the art will readily recognize that the equivalent of such software can also be constructed in hardware. Because image manipulation algorithms and systems are well known, the present description will be directed in particular to algorithms and systems forming part of, or cooperating more directly with, the method in accordance with the present invention. Other aspects of such algorithms and systems, together with hardware and software for producing and otherwise processing the image signals involved therewith, not specifically shown or described herein is selected from such systems, algorithms, components, and elements known in the art. Given the system as described according to the invention in the following, software not specifically shown, suggested, or described herein that is useful for implementation of the invention is conventional and within the ordinary skill in such arts.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

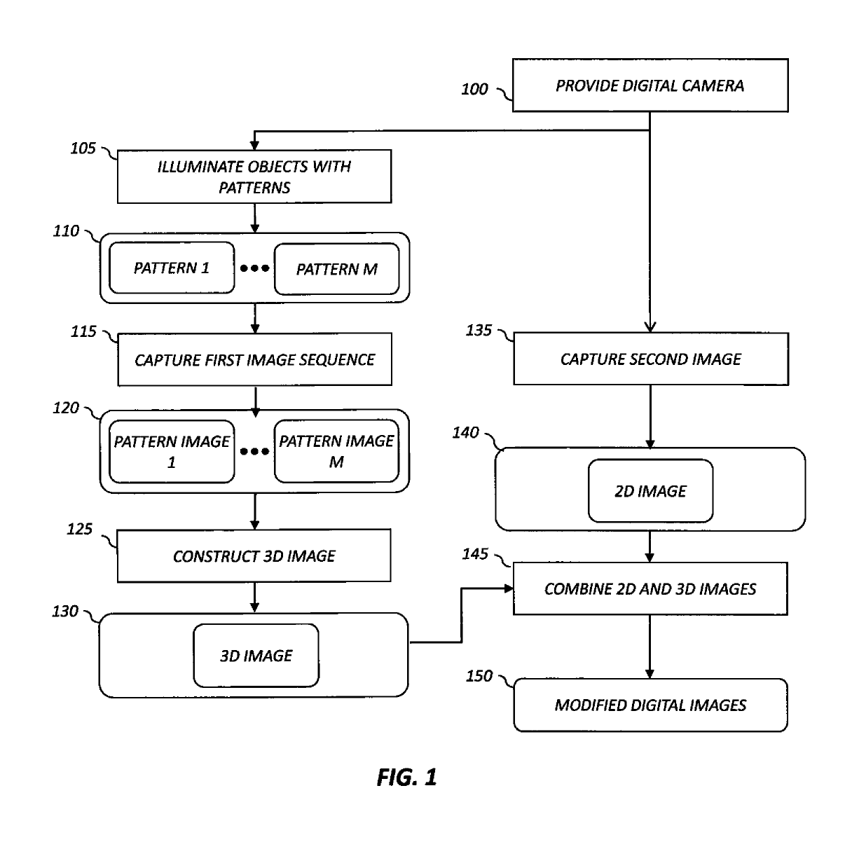

FIG. 1 is a flow chart of a method of operating a digital camera to produce a modified digital image of a scene using structured illumination, in accord with the present invention. Referring to FIG. 1, the method includes the steps of: 100 providing a digital camera, the digital camera including a capture lens, an image sensor, a projector and a processor; 105 using the projector to illuminate one or more objects with a sequence of patterns 110; 115 capturing a first sequence of digital images 120 of the illuminated objects including the reflected patterns that have depth information, referred to in FIG. 1 as a Pattern Image; 125 using the processor to analyze the first sequence of digital images including the depth information to construct a 3D digital image 130 of the objects; 135 capturing a second, 2D digital image 140 of the objects and the remainder of the scene without the reflected pattern and; 145 using the processor to combine the 3D and 2D digital images to produce a modified digital image 150 of the illuminated objects and the remainder of the scene.

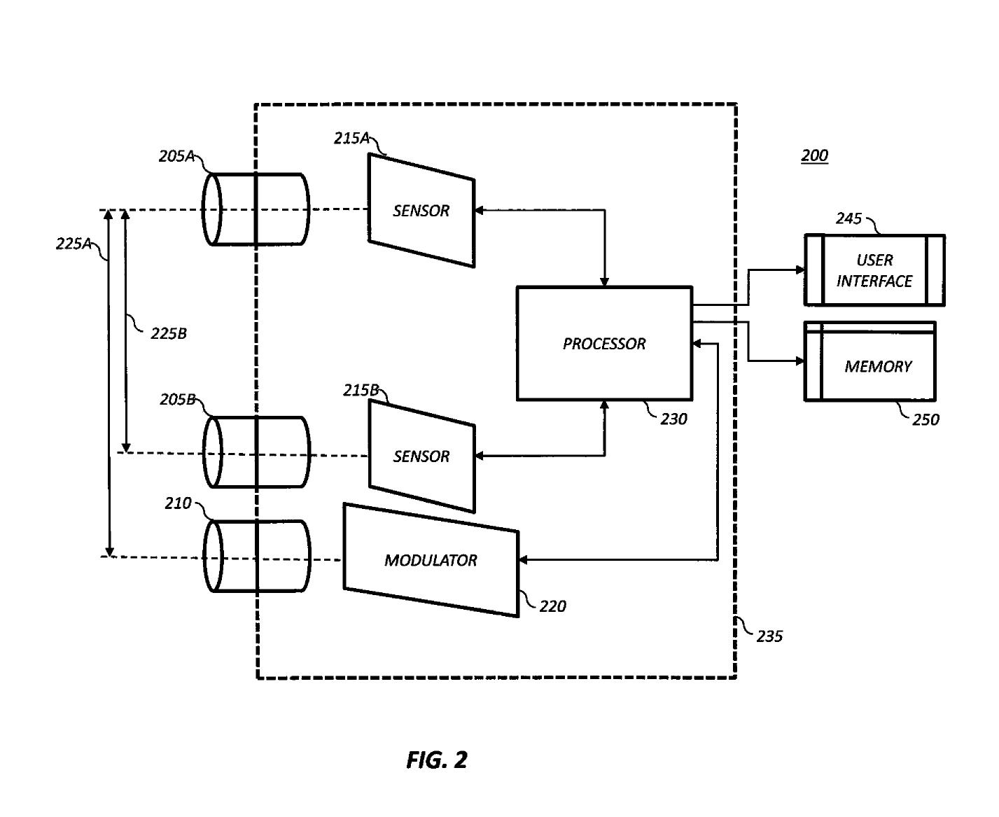

FIG. 2 is a schematic of a digital camera 200 in accord with the present invention, in which the digital camera has two lenses and two sensors, one high resolution sensor and one low resolution sensor. The phrase “digital camera” is intended to include any device including a lens which forms a focused image of a scene at an image plane, wherein an electronic image sensor is located at the image plane for the purposes of recording and digitizing the image. These include a digital camera, cellular phone, digital video camera, surveillance camera, web camera, television camera, electronic display screen, tablet or laptop computer, video game sensors, multimedia device, or any other device for recording images.

Referring to FIG. 2, in a preferred embodiment the digital camera 200 is comprised of two capture lenses 205A and 205B, with corresponding image sensors 215A and 215B, a projection lens 210 and a light modulator 220. The capture lens 205A and the projection lens 210 are horizontally separated and aligned along a first stereo baseline 225A which, along with other factors such as the resolution of the sensors and the distance to the scene, determines the depth resolution of the camera.

The light modulator 220 is a digitally addressed, pixelated array such as a reflective LCD, LCoS, or Texas Instruments DLP™ device, or a scanning engine, which is projected onto the scene by the projection lens 210. Many illumination systems for such modulators are known in the art and are used in conjunction with such devices. The illumination system for the modulator, and hence for the structured lighting system comprised of the capture lens 205A, image sensor 215A, projection lens 210 and light modulator 220 can operate in visible or non-visible light. In one configuration, near-infrared illumination is used to illuminate the scene objects, which is less distracting to people who are in the scene, provided that the intensity is kept at safe levels. Use of infrared wavelengths is advantageous because of the native sensitivity of silicon based detectors at such wavelengths.

The camera 200 also includes a processor 230 that communicates with the image sensors 215A and 215B, and light modulator 220. The camera 200 further includes a user interface system 245, and a processor-accessible memory system 250. The processor-accessible memory system 250 and the user interface system 245 are communicatively connected to the processor 230. In one configuration, such as the one shown in FIG. 2, all camera components except for the memory 250 and the user interface 245 are located within an enclosure 235. In other configurations, the memory 250 and the user interface 245 can also be located within or on the enclosure 235.

The processor 230 can include one or more data processing devices that implement the processes of the various embodiments of the present invention, including the example processes of FIGS. 1, 3, 4, 5, 6 and 7 described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

The processor-accessible memory system 250 includes one or more processor-accessible memories configured to store information, including the information needed to execute the processes of the various embodiments of the present invention, including the example processes of FIGS. 1, 3, 4, 5, 6 and 7 described herein. In some configurations, the processor-accessible memory system 250 is a distributed processor-accessible memory system including multiple processor-accessible memories communicatively connected to the processor 230 via a plurality of computers or devices. In some configurations, the processor-accessible memory system 250 includes one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data is communicated. Further, the phrase “communicatively connected” is intended to include a connection between devices or programs within a single data processor, a connection between devices or programs located in different data processors, and a connection between devices not located in data processors at all. In this regard, although the processor-accessible memory system 250 is shown separately from the processor 230, one skilled in the art will appreciate that it is possible to store the processor-accessible memory system 250 completely or partially within the processor 230. Furthermore, although it is shown separately from the processor 230, one skilled in the art will appreciate that it is also possible to store the user interface system 245 completely or partially within the processor 230.

The user interface system 245 can include a touch screen, switches, keyboard, computer, or any device or combination of devices from which data is input to the processor 230. The user interface system 245 also can include a display device, a processor-accessible memory, or any device or combination of devices to which data is output by the processor 230. In this regard, if the user interface system 245 includes a processor-accessible memory, such memory can be part of the processor-accessible memory system 250 even though the user interface system 245 and the processor-accessible memory system 250 are shown separately in FIG. 2.

Capture lenses 205A and 205B form independent imaging systems, with lens 205A directed to the capture the sequence of digital images 120, and lens 205B directed to the capture of the 2D image 140. Image sensor 215A should have sufficient pixels to provide an acceptable 3D reconstruction when used with the spatial light modulator 220 at the resolution selected. Image sensor 215B should have sufficient number of pixels to provide an acceptable 2D image capture and enhanced output image. In a preferred configuration, the structured illumination system can have lower resolution than the 2D image capture system, so that image sensor 215B will have lower resolution than image sensor 215A. In one example, image sensor 215A has VGA resolution (640×480 pixels) and image sensor 215B has 1080p resolution (1920×1080 pixels). Furthermore, as known in the art, modulator 220 can have resolution slightly higher than sensor 215A, in order to assist with 3D mesh reconstruction, but again this resolution is not required to be higher than sensor 215B. The capture lens 205A and the capture lens 205B can also be used as a stereo image capture system, and are horizontally separated and aligned along a second stereo baseline 225B which, along with other factors known in the art such as the resolution of the projector and sensor, and the distance to the scene, determines the depth resolution of such a stereo capture system.

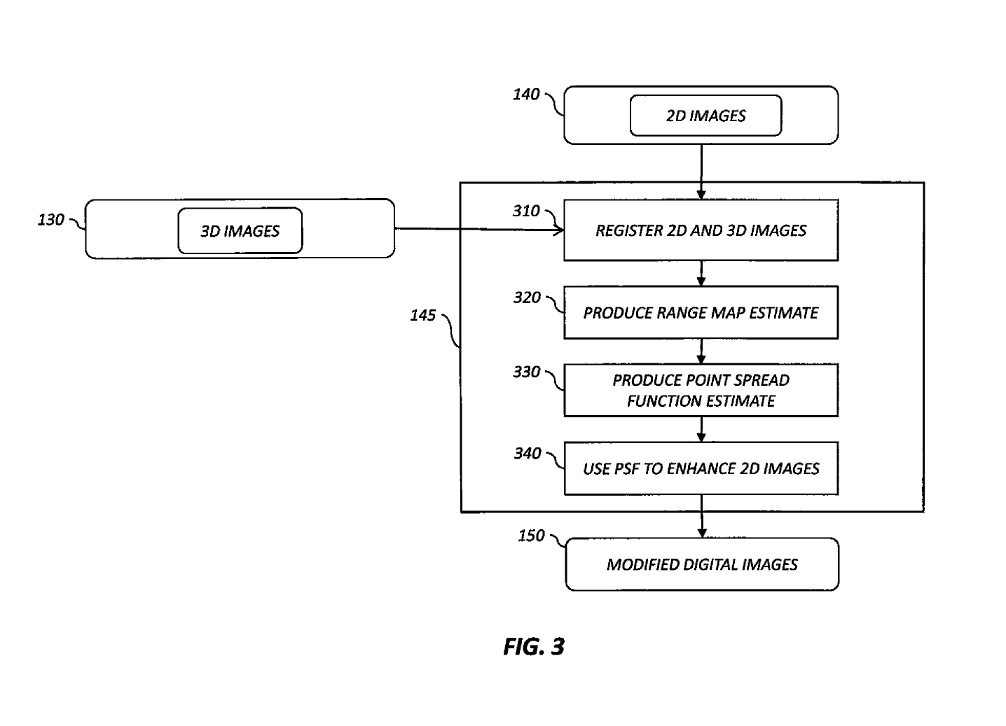

In another configuration, the camera is comprised of a single lens and sensor, for example in FIG. 3, lens 205A and image sensor 215A. In this configuration, the single capture unit serves to produce both the 3D image 130 and the 2D image 140. This requires that the image sensor 215A have sufficient resolution to provide an acceptable 2D image capture and enhanced output image, as in the preferred configuration. As described above, the structured illumination capture has lower resolution than the 2D image capture, so that in this configuration, when image sensor 215A is used to capture the sequence of digital images 120, it is operated at lower resolution than when it is used to capture the 2D image 140. In one configuration this is achieved by using CMOS sensor technology that permits direct addressing and on-chip processing of the sensor pixels, so that the captured pattern image data is spatially averaged and sub-sampled efficiently before sending to the processor 230. In another configuration, the spatial averaging and sub-sampling is performed by the processor 230.

Returning to FIG. 1, the sequence of patterns 110 used to produce the sequence of digital images 120 can include, but is not limited to, spatially periodic binary patterns such as Ronchi Rulings or square wave gratings, periodic gray scale patterns such as sine waves or triangle (saw-tooth) waveforms, or dot patterns.

In a preferred configuration, the sequence of patterns 110 includes both spatially periodic binary and grayscale patterns, wherein the set of periodic grayscale patterns each has the same frequency and a different phase, the phase of the grayscale illumination patterns each having a known relationship to the binary illumination patterns. The sequence of binary illumination patterns is first projected onto the scene, followed by the sequence of periodic grayscale illumination patterns. The projected binary illumination patterns and periodic grayscale illumination patterns share a common coordinate system having a projected x coordinate and a projected y coordinate, the projected binary illumination patterns and periodic grayscale illumination patterns varying with the projected x coordinate and being constant with the projected y coordinate.

It should be noted that in addition to capturing a sequence of pattern images 110, from which a single 3D image 130 is produced, the invention is inclusive of the capture of multiple scenes, i.e. video capture, wherein multiple repetitions of the pattern sequence are projected, one sequence per video frame. In some configurations, different pattern sequences are assigned to different video frames. Similarly, the captured second image 135 can also be a video sequence. In any configuration, video image capture requires projection of the structured illumination patterns at a higher frame rate than the capture of the scene without the patterns. Recognizing the capability of operating with either single or multiple scene frames, the terms “3D image” and “2D image” are used in the singular with reference to FIG. 1, and are used in the plural in subsequent figures.

Again referring to FIG. 1, the final step in the method is 145 using the processor to process the 2D and 3D digital images to produce a modified digital image 150 of the illuminated objects and the remainder of the scene. A number of image modifications based upon the 3D image 130, and data derived from it, are possible within the scope of the invention. FIG. 3 is a flow chart depicting the operations comprising step 145 in one configuration of the invention, wherein a scene range map and point spread function are estimated to aid in the image enhancement. In FIG. 3, the 3D digital image 130 and the 2D digital image 140 of the objects and the remainder of the scene without the reflected pattern are first registered 310, and then processed to produce 320 a scene range map estimate.

Any method of image registration known in the art is used in step 310. For example, the paper “Image Registration Methods: A Survey” by Zitova and Flusser (Image and Vision Computing, Vol. 21, pp. 977-1000, 2003) provides a review of the two basic classes of registration algorithms (area-based and feature-based) as well as the steps of the image registration procedure (feature detection, feature matching, mapping function design, image transformation and resampling). The scene range map estimate 320 can be derived from the 3D images 130 and 2D images 140 using methods known in the art. In a preferred arrangement, the range map estimation is performed using the binary pattern and periodic grayscale images described above. The binary pattern images are analyzed to determine coarse projected x coordinate estimates for a set of image locations, and the captured grayscale pattern images are analyzed to determine refined projected x coordinate estimates for the set of image locations. Range values are then determined according to the refined projected x coordinate estimates, wherein a range value is a distance between a reference location and a location in the scene corresponding to an image location. Finally, a range map is formed according to the refined range value estimates, the range map comprising range values for an array of image locations, the array of image locations being addressed by 2D image coordinates.

Returning to FIG. 3, a point spread function estimate is produced 330 from the range data, and the point spread function estimate is used 340 to modify the 2D images 140, resulting in modified digital images 150. The point spread function (PSF) is a two dimensional function that specifies the intensity of the light in the image plane due to a point light source at a corresponding location in the object plane. Methods for determining the PSF include capturing an image of a small point-like source of light, edge targets or spatial frequency targets, and processing such images using known mathematical relationships to yield a PSF estimate. The PSF is a function of the object distance (range or depth) and the position of the image sensor relative to the focal plane, so that a complete characterization requires the inclusion of these variables. Therefore, the problem of determining range information in an image is similar to the problem of decoding spatially-varying blur, wherein the spatially-varying blur is a function of the distance of the object from the camera's plane of focus in the object space, or equivalently, the distance from the object to the camera. It is clear to those skilled in the art that this method can also be reversed, so that once the PSF of a camera is known as a function of focus position, and defocus positions (object ranges), then given a range map of objects in the scene, the PSF at any location in the scene can be estimated from the range data.

The PSF can be used in a number of different ways to process the 2D images 140. These include, but are not limited to, image sharpening, deblurring and deconvolution, and noise reduction. Many examples of PSF-based image processing are known in the art, and are found in standard textbooks on image processing.

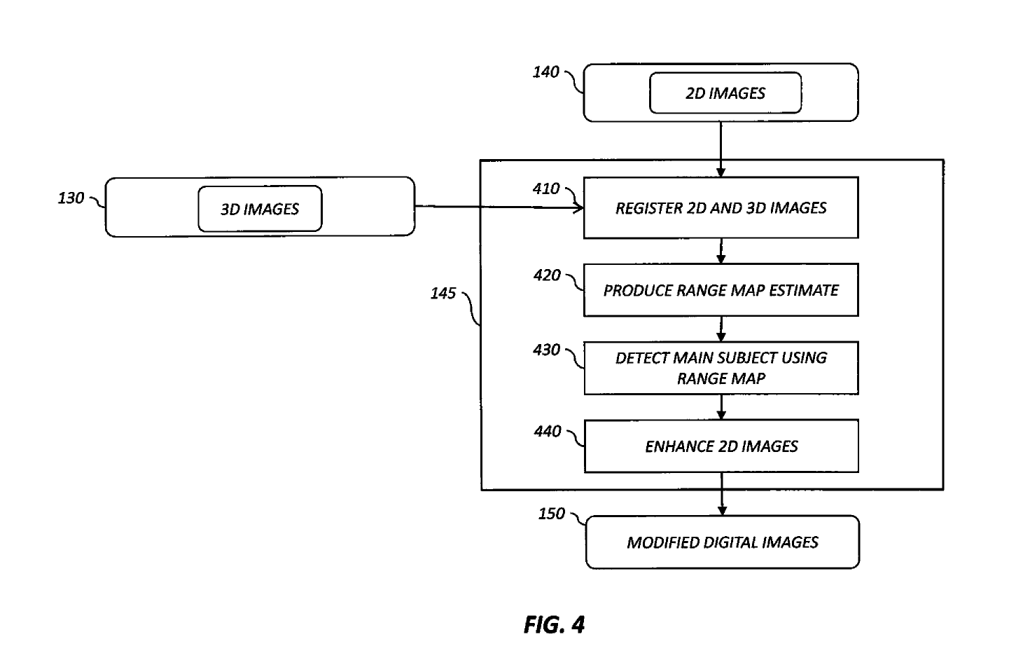

FIG. 4 is a flow chart depicting the operations comprising step 145 in another configuration of the invention, wherein a scene range map is estimated and main subject detected to aid in the image enhancement. In FIG. 4, the 3D digital image 130 and the 2D digital image 140 of the objects and the remainder of the scene without the reflected pattern are first registered 410, and then processed to produce 420 a scene range map estimate. Next, the main subject in the scene is detected 430 using the information in the range map. Identifying the main subject permits enhancement 440 of the 2D images 140 to produce modified digital images 150. Main subject detection algorithms are known in the prior art. In a preferred configuration, the main subject detection using range map data is performed using the techniques taught in commonly assigned, co-pending U.S. Patent Publication No. 20110038509, entitled: “Determining main objects using range information”, by S. Wang, incorporated herein by reference.

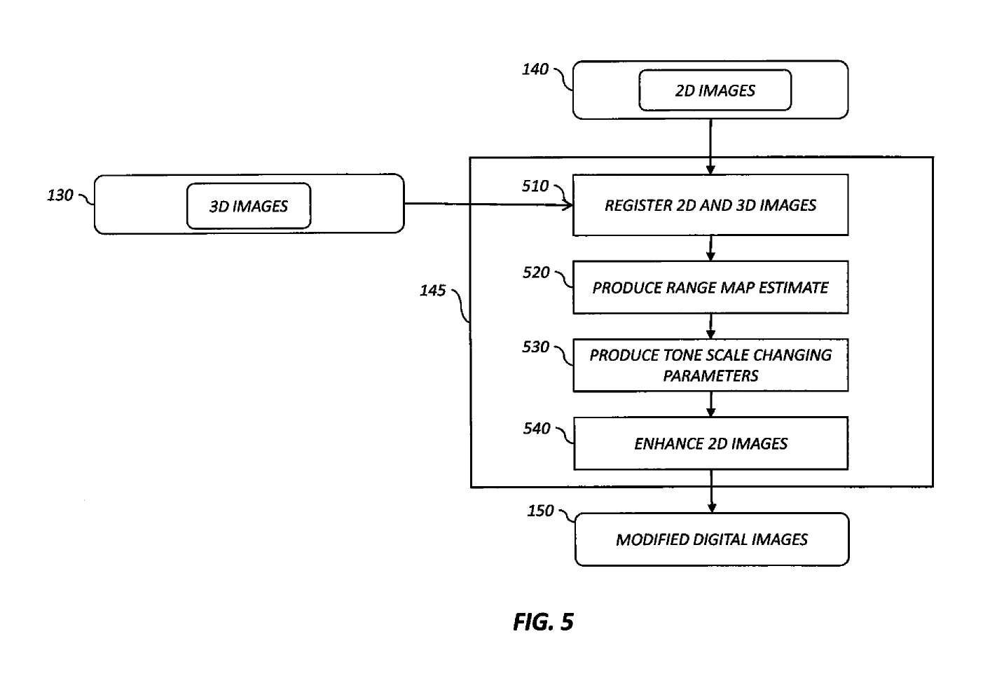

FIG. 5 is a flow chart depicting the operations comprising step 145 in another configuration of the invention, wherein a scene range map is estimated and tone scale changing parameters are produced to aid in the image enhancement. In FIG. 5, the 3D digital image 130 and the 2D digital image 140 of the objects and the remainder of the scene without the reflected pattern are first registered 510, and then processed to produce 520 a scene range map estimate. Next, tone scale changing parameters are produced 530 using the information in the range map. The tone scale changing parameters are used 540 to enhance the 2D images 140 to produce modified digital images 150. Methods for deriving tone scale changing parameters from digital images are known in the art. In a preferred configuration, the tone scale changing parameters are used 540 to enhance the 2D images 140 using the techniques taught in commonly assigned, co-pending U.S. Patent Publication No. 20110026051, entitled: “Digital image brightness adjustment using range information”, by S. Wang, incorporated herein by reference.

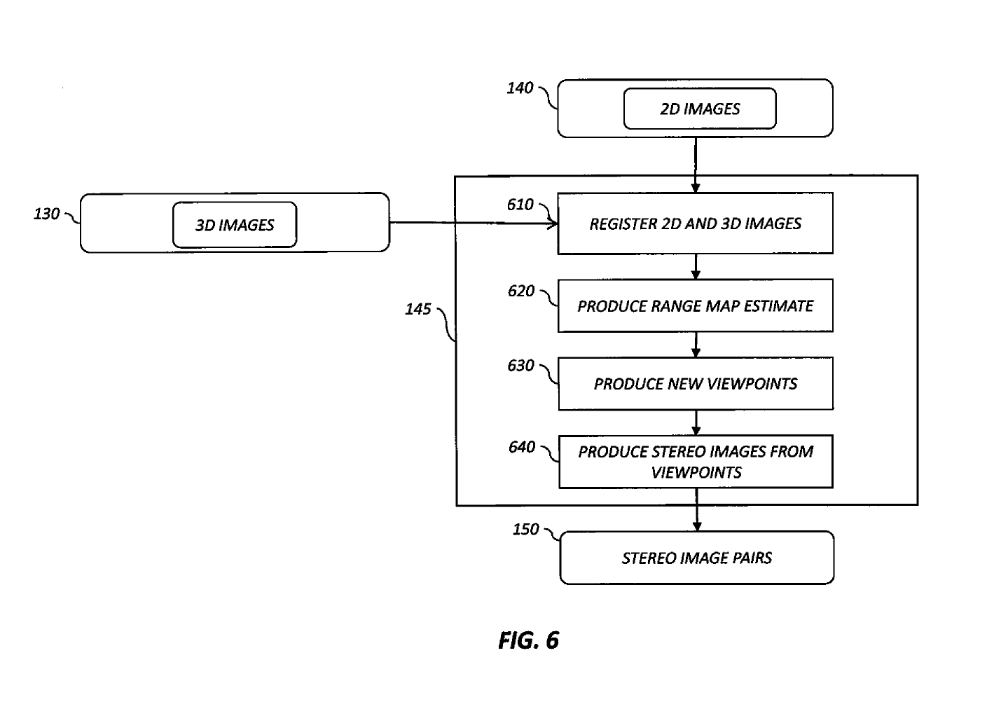

FIG. 6 is a flow chart depicting the operations comprising step 145 in another configuration of the invention, wherein a scene range map is estimated and new viewpoints are produced in order to generate stereoscopic image pairs. In FIG. 6, the 3D digital image 130 and the 2D digital image 140 of the objects and the remainder of the scene without the reflected pattern are first registered 610, and then processed to produce 620 a scene range map estimate. Next, two new 2D images 140 with new viewpoints are produced 630. Algorithms for computing new viewpoints from existing 2D and 3D images with range data are known in the art, see for example “View Interpolation for Image Synthesis” by Chen and Williams (ACM SIGGRAPH 93, Proceedings of the 20^{th} Annual Conference on Computer Graphics and Interactive Techniques, 1993). Furthermore, the new viewpoints produced can correspond to the left eye view (L image) and right eye view (R image) of a stereoscopic image pair as seen by a virtual camera focused on the scene from a specified viewpoint. In this manner, L and R stereoscopic views are produced 640, resulting in modified images 150 which are stereoscopic image pairs.

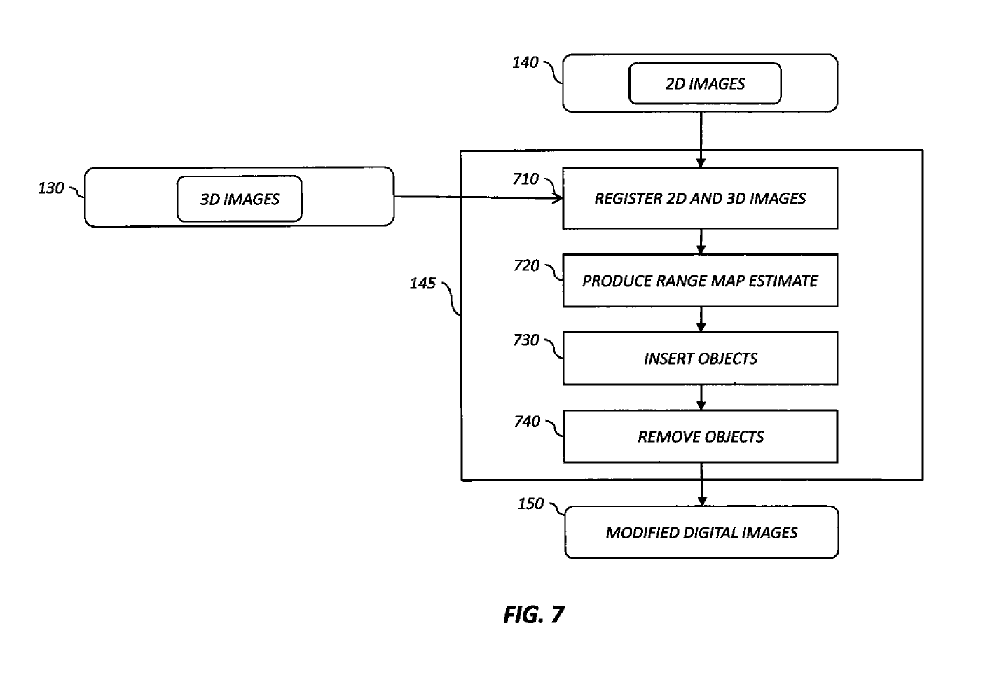

FIG. 7 is a flow chart depicting the operations comprising step 145 in another configuration of the invention, wherein a scene range map is estimated and objects are inserted or removed from a digital image. In FIG. 7, the 3D digital image 130 and the 2D digital image 140 of the objects and the remainder of the scene without the reflected pattern are first registered 710, and then processed to produce 720 a scene range map estimate. Next, new objects are inserted 730 into the 3D images 130 and 2D images 140 using the information in the range map. Also, objects are removed 740 from the 3D images 130 and 2D images 140 using the information in the range map, resulting in modified digital images 150. Methods for inserting or removing objects from digital images based on knowledge of the range map are known in the art. For example, such methods are described by Shade et al. in “Layered Depth Images”, SIGGRAPH 98 Proceedings, pp. 231-242 (1998).

In addition to producing the modified digital images 150, the processor 230 can send images or data to the user interface system 245 for display. In particular, the processor 230 can communicate a series of 2D 140 or 3D 130 images to the user interface system 245 that indicate the appearance of a scene, or objects in a scene, from a series of perspectives or viewpoints. The range of viewpoints available for a particular scene or object is determined by the stereo baseline of the system and the distance to the scene at the time of capture. Additional viewpoints or perspectives are included by taking additional captures. The images sent to the user interface system 245 can include the 3D images 130, the 2D images 140 and the modified digital images 150. Similarly, the processor 230 can send images or data to a database for storage and later retrieval. This database can reside on the processor-accessible memory 250 or on a peripheral device. The data can include parameters that define the 3D structure of a scene from a series of viewpoints. Such parameters are retrieved from the database and sent to the processor 230 and to the user interface 245. Furthermore, parameters retrieved from the database are compared to parameters recently computed from a captured image for purposes of object or scene identification or recognition.

The invention has been described in detail with particular reference to certain preferred embodiments thereof, but it will be understood that variations and modifications are effected within the spirit and scope of the invention.

### PARTS LIST

100 provide digital camera step
105 illuminate objects step
110 sequence of patterns
115 capture first image sequence step
120 sequence of digital images
125 analyze sequence of digital images step
130 3D digital images
135 capture 2D digital image step
140 2D digital images
145 combine 2D and 3D digital images step
150 modified digital images
200 digital camera
205A capture lens
205B capture lens
210 projection lens
215A image sensor
215B image sensor
220 light modulator
225A first stereo baseline
225B second stereo baseline
230 processor
235 enclosure
245 user interface system
250 processor-accessible memory system
310 image registration step
320 produce range map step
330 produce point spread function step
340 enhance 2D images step
410 image registration step
420 produce range map step

### PARTS LIST (CON'T)

430 detect main subject step
440 enhance 2D images step
510 register images step
520 produce range map step
530 produce tone scale parameters step
540 enhance 2D images step
610 register images step
620 produce range map step
630 produce new viewpoints step
640 produce stereo images step
710 register images step
720 produce range map step
730 insert objects step
740 remove objects step

1. A method of operating a digital camera, comprising:
a) providing a digital camera, the digital camera including a capture lens, an image sensor, a projector and a processor;
b) using the projector to illuminate one or more objects with a sequence of patterns;
c) capturing a first sequence of digital images of the illuminated objects including the reflected patterns that have depth information;
d) using the processor to analyze the first sequence of digital images including the depth information to construct a 3D digital image of the objects;
e) capturing a second, 2D digital image of the objects and the remainder of the scene without the reflected patterns; and
f) using the processor to combine the 2D and 3D digital images to produce a modified digital image of the illuminated objects and the remainder of the scene.

2. The method according to claim 1, wherein the digital camera has two lenses and two sensors, one high resolution sensor and one low resolution sensor.

3. The method according to claim 1, wherein the projector illuminates the objects with infrared (non-visible) light.

4. The method according to claim 1, wherein the projected patterns are spatially periodic.

5. The method according to claim 1, wherein combining the 2D and 3D digital images further includes:
i) producing a range map of the scene;
ii) using the range map to estimate the spatially varying point spread function; and
iii) using the point spread function estimate to produce a modified digital image of the illuminated objects and the remainder of the scene.

6. The method according to claim 1, wherein combining the 2D and 3D digital images further includes:
i) producing a range map of the scene;
ii) using the range map detect the main subject of the scene;
iii) using the detected main subject to enhance the 2D images; and
iv) using the enhanced 2D images to produce a modified digital image of the illuminated objects and the remainder of the scene.

7. The method according to claim 1, wherein combining the 2D and 3D digital images further includes:
i) producing a range map of the scene;
ii) using the range map to produce tone scale changing parameters;
iii) using the tone scale parameters to enhance the 2D images; and
iv) using the enhanced 2D images to produce a modified digital image of the illuminated objects and the remainder of the scene.

8. The method according to claim 1, wherein combining the 2D and 3D digital images further includes:
i) producing a range map of the scene; and
ii) using the range map to produce images corresponding to new viewpoints of the original scene.

9. The method according to claim 8, wherein the new viewpoints form stereoscopic image pairs.

10. The method according to claim 1, wherein the processor inserts objects into or removes objects from the second 2D digital image to produce the-modified digital image.

11. The method according to claim 1, wherein the processor further communicates a series of images to a user interface indicating the appearance of a scene from a series of viewpoints.

12. The method according to claim 1, wherein the processor further communicates a series of parameters to a database defining the 3D structure of a scene from a series of viewpoints.

13. The method according to claim 1, wherein the processor further retrieves a series of parameters from a database defining the 3D structure of a scene from a series of viewpoints.

14. The method according to claim 13, wherein the processor further compares the retrieved parameters to captured parameters for purposes of object recognition.
